(19) United States
(12) Patent Application Publication
(10) Pub. No.: US 2025/0244531 A1
(43) Pub. Date: Jul. 31, 2025

(54) ZONED DEPTH STRUCTURES

(71) Applicant: Snap Inc., Santa Monica, CA (US)

(72) Inventors: Benjamin John Broughton, Oxford (GB); Alexander Drayton, Abingdon (GB); Parashara Panduranga, Banbury (GB); Roland Piper, London (GB)

(21) Appl. No.: 18/986,349

(22) Filed: Dec. 18, 2024

Related U.S. Application Data
(60) Provisional application No. 63/614,343, filed on Dec. 22, 2023.

(51) Int. Cl. G02B 6/136; G02B 6/12

(52) U.S. Cl. CPC G02B 6/136; G02B 2006/12038; G02B 2006/12107; G02B 2006/12173

(57) ABSTRACT

A waveguide has a plurality of repeating structures formed on or in its surface by imprinting a negative model over at least a portion of the waveguide surface. The negative model is formed by operations including performing a first etch of a first depth into a plurality of first-etch regions, performing a second etch of a second depth into a plurality of second-etch regions, and performing a third etch of a third depth into one or more third-etch regions of a surface of a substrate. The etches form one or more deep depressions having a depth equal to the sum of the first depth, the second depth, and the third depth, and a plurality of shallower depressions each having a respective depth equal to a sum of one or two of the following depths: the first depth, the second depth, and the third depth.

### CLAIM OF PRIORITY

This application claims the benefit of priority to U.S. Provisional Application Ser. No. 63/614,343, filed on Dec. 22, 2023, which is incorporated herein by reference in its entirety.

### TECHNICAL FIELD

The present disclosure relates generally to subtractive manufacturing and more particularly to structures etched to multiple depths.

### BACKGROUND

Subtractive manufacturing techniques are commonly used to fabricate optical devices and components. This involves selectively removing material from a substrate through an etching process to generate the desired structures and profiles. One approach is to utilize a single etching step to create single level diffractive optical elements. However, more complex optical properties can be achieved by etching to multiple depths. Examples of etching techniques for forming diffractive optical elements are described in U.S. Patent Application Publication No. 2004/0131949 A1, published Jul. 8, 2004, listing Masaaki Kurihara and Nobuhito Toyama as co-inventors (hereinafter the “Kurihara reference”).

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates an example method for subtractive manufacturing, in accordance with some examples.

FIG. 2 illustrates a cross-sectional view of an example substrate and mask formed according to the method of FIG. 1, in accordance with some examples.

FIG. 3 illustrates the substrate of FIG. 2 after a first etch according to the method of FIG. 1, in accordance with some examples.

FIG. 4 illustrates the substrate of FIG. 3 with a re-formed mask according to the method of FIG. 1, in accordance with some examples.

FIG. 5 illustrates the substrate of FIG. 4 after a second etch according to the method of FIG. 1, in accordance with some examples.

FIG. 6 illustrates the substrate of FIG. 5 with a re-formed mask according to the method of FIG. 1, in accordance with some examples.

FIG. 7 illustrates the substrate of FIG. 6 after a third etch according to the method of FIG. 1, in accordance with some examples.

FIG. 8 illustrates a cross-sectional view of an example positive model and an example negative model formed in accordance with some examples.

FIG. 9 illustrates example sub-steps of first etch and second etch operations of the method of FIG. 1, in accordance with some examples.

FIG. 10 illustrates a cross-sectional view of an example substrate, first mask, and second mask formed according to the sub-steps of FIG. 9, in accordance with some examples.

FIG. 11 illustrates the substrate of FIG. 10 after a third etch according to the method of FIG. 1, in accordance with some examples.

FIG. 12 illustrates the substrate of FIG. 11 after a fourth etch according to the method of FIG. 1, in accordance with some examples.

FIG. 13 shows an overhead view of a rectangular pyramid formed into a substrate by stacked etches, in accordance with some examples.

FIG. 14 shows an overhead view of a sequence of stacked etches used to form a cruciform pyramid into a substrate, in accordance with some examples.

### DETAILED DESCRIPTION

Examples are described herein that provide techniques for subtractive manufacturing of a structure using etches into a substrate. Etches into the substrate are stacked by partially overlapping the etched regions, thereby reducing the number of process steps (e.g., lithography steps and etching steps) but achieve a large variety of depths. In some examples, a number N of distinct etches into the substrate can form a pattern of depressions in the substrate that have among them up to 2^{N}−1 different depths. This exponential scaling of the number of different depths that can be achieved through etching may enable a range of useful applications that are not feasible using conventional subtractive manufacturing techniques, which typically require a separate etch for each distinct depth. Thus, examples described herein may address the technical problem of how to form, via etching, depressions having a large number of distinct depths with a relatively small number of etching operations and the other process steps attendant thereon, such as lithographic operations.

A hard master formed using examples described herein can be used to form a set of structures through imprinting or molding, wherein the structures have widely varying shapes and/or sizes across the surface on which they are imprinted or molded. The wide variation in shapes and/or sizes of the structures may enable approaches to the formation of optical structures on or in waveguide surfaces that address one or more technical problems arising in the context of optical device fabrication, such as optical inefficiency, optical non-uniformity, and/or optical discontinuity, as described in further detail below.

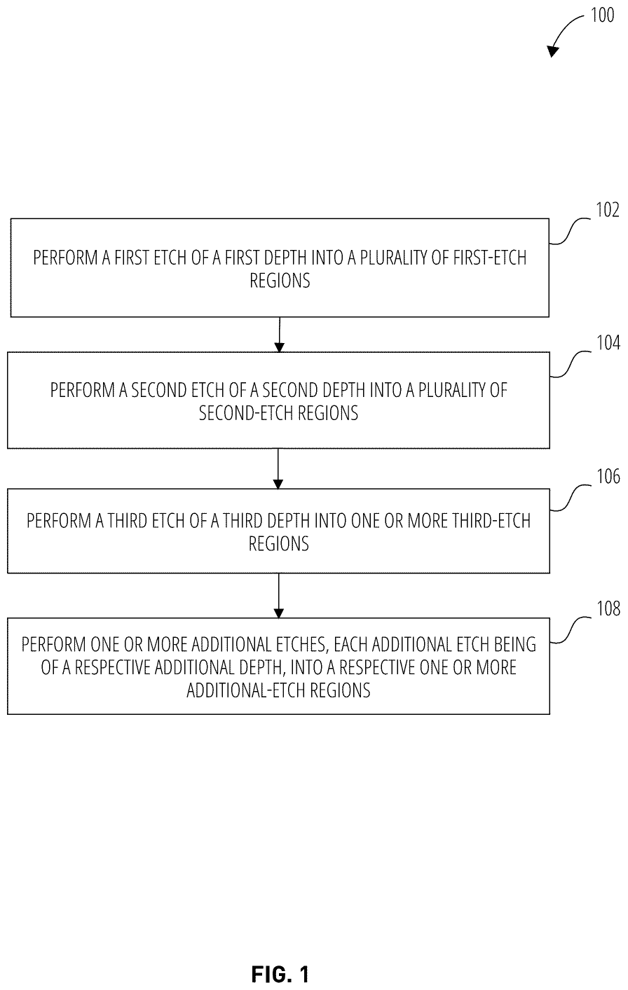

FIG. 1 illustrates an example method 100 for subtractive manufacturing. Although the example method 100 depicts a particular sequence of operations, the sequence may be altered without departing from the scope of the present disclosure. For example, some of the operations depicted may be performed in parallel or in a different sequence that does not materially affect the function of the method 100. In other examples, different components of an example device or system that implements the method 100 may perform functions at substantially the same time or in a specific sequence.

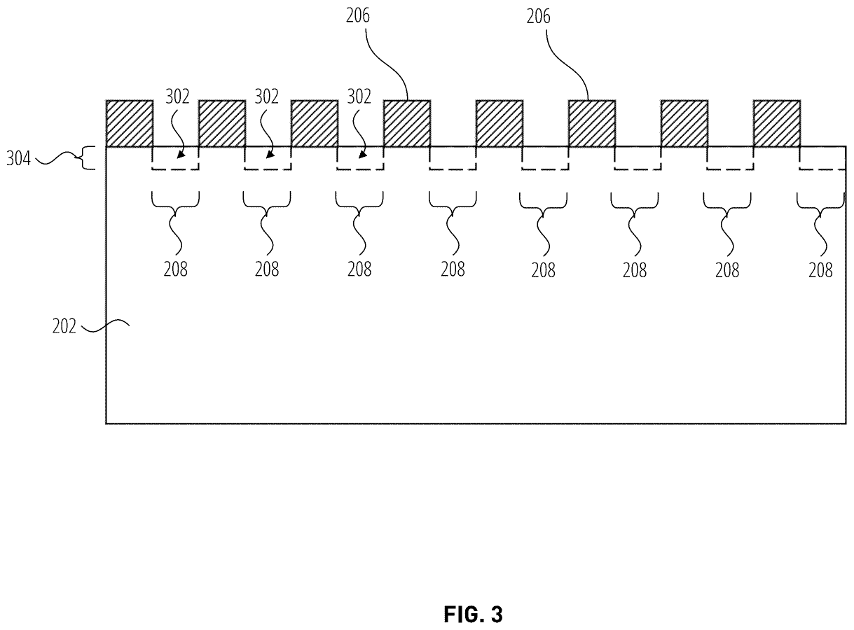

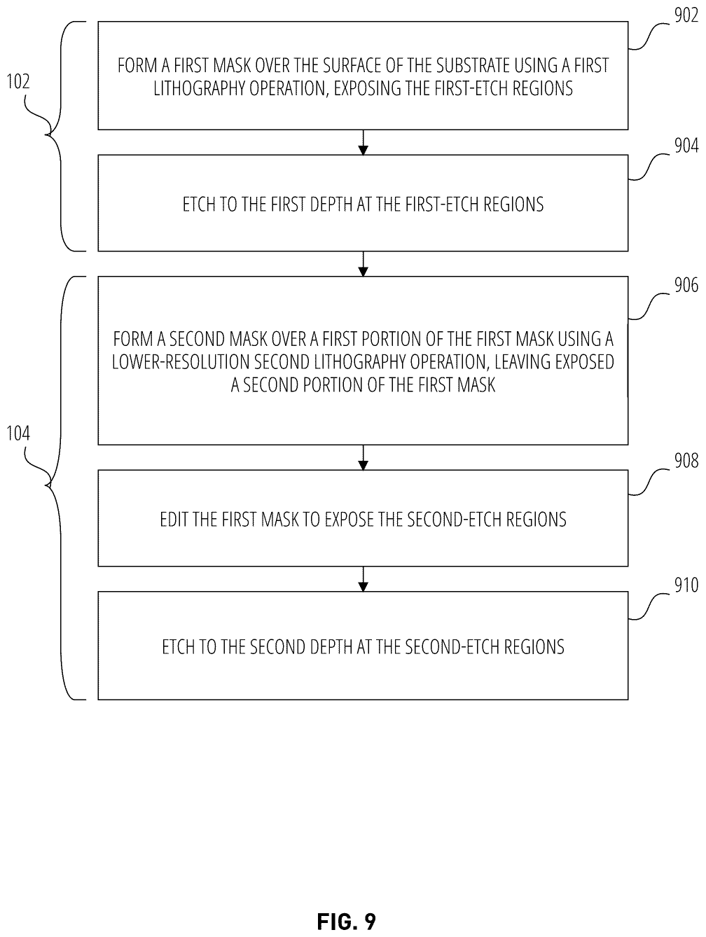

According to some examples, the method 100 includes performing a first etch of a first depth into a plurality of first-etch regions of a surface of a substrate at operation 102. The substrate may be any suitable substrate for subtractive manufacturing. In some examples, the substrate is a hard crystal or metal structure suitable for forming a hard master for imprinting, such as quartz. In some examples, the first etch is performed using a first mask, as described in greater detail below with reference to FIG. 9. An example cross-sectional view of a substrate being etched by the first etch is described below with reference to FIG. 3.

According to some examples, the method 100 includes performing a second etch of a second depth into a plurality of second-etch regions of the surface of the substrate at operation 104. In some examples, the second etch is performed using a second mask, as described in greater detail below with reference to FIG. 9. In some examples, the plurality of second-etch regions are different from the plurality of first-etch regions, but at least partially overlap the plurality of first-etch regions at one or more overlap regions. An example cross-sectional view of a substrate being etched by the first etch is described below with reference to FIG. 3.

According to some examples, the method 100 includes performing a third etch of a third depth into one or more third-etch regions of the surface of the substrate at operation 106.

According to some examples, the method includes performing one or more additional etches, each additional etch being of a respective additional depth, into a respective one or more additional-etch regions of the surface of the substrate at operation 108. In some examples, the one or more third-etch regions are different from the plurality of first-etch regions and different from the plurality of second-etch regions, but at least partially overlap at least one of the one or more overlap regions.

The product of the first etch, second etch, and third etch is the formation of a plurality of depressions, including one or more deep depressions and a plurality of shallower depressions. The deep depressions, formed at the overlap of the third-etch regions with the overlap regions, have a depth equal to a sum of the first depth, the second depth, and the third depth. The shallower depressions may have a range of different depths depending on the pattern of overlap of the three etches. Each shallower depression has a respective depth equal to a sum of one or two of the following depths: the first depth, the second depth, and the third depth.

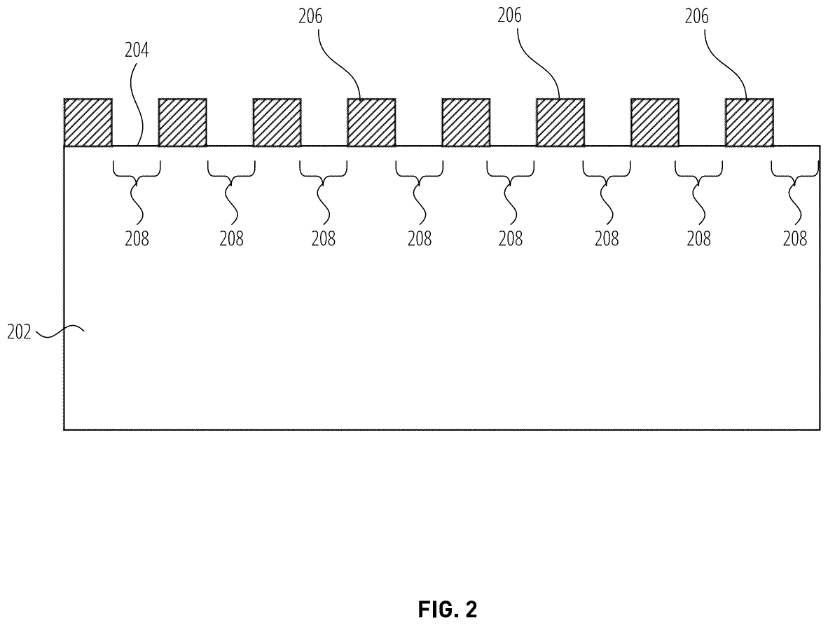

An example configuration of etches into a substrate are illustrated and described below with reference to FIG. 2 through FIG. 7.

It will be appreciated that, depending on the respective depths selected for the various etches, a large number of depressions of different depths may be formed by the method 100 using a relatively small number of etches. In examples using three etches (e.g., by omitting operation 108), the number of different depths that may be achieved is equal to seven: first depth, second depth, third depth, first depth+second depth, first depth+third depth, second depth+third depth, and first depth+second depth+third depth. As the number of etches increases, the number of potential depths scales exponentially. Thus, in examples that include one or more iterations of operation 108 to perform more than three etches, the total number of different depths of depressions that may be formed by N etches is equal to 2^{N}−1 (if counting the substrate surface itself as a depression of depth zero, the number of depths is equal to 2^{N}). Because etches can be performed over a large area of a substrate surface using techniques such as lithography, this means that a large number M of different structure depths may be achieved using only log₂(M+1) etches. This may be significantly more efficient than conventional subtractive manufacturing techniques, which typically require M etches to achieve M different depths. The efficiency of method 100 and other examples described herein may make new fabrication techniques feasible that were previously too resource-intensive, or resulted in too many defects or other artifacts due to the large number of etching operations required, to be usefully deployed. Examples of such techniques could include formation of hard masters for imprinting of large numbers of repeated structures across a surface, the structures varying gradually across the surface. In some cases, the structures may vary gradually in their top-down shape defined within the plane of the substrate surface, such that the shape of the structures gradually changes from a first shape in a first region of the surface to a second shape in a second region of the surface. In some cases, the structures may vary gradually in their cross-sectional shape, e.g., their height (which may be defined by the depth of the depressions in the hard master).

Gradual changes in height may be achieved, in some cases, by using a large number of different depths for the depressions used to form the structures, such that a large number of step-changes in height may be used to gradually modulate the height of structures in different regions. Gradual changes in shape may be achieved, in some cases, by leveraging the flexibility provided by the large number of different depths for the depressions used to form the structures: for example, shapes with stepped sides of different slopes may be gradually changed by using the large number of available depression depths to transition from a first stepped side with a first slope to a second stepped side with a second slope.

In some examples, a hard master may be created, using examples described herein, for imprinting nanometer-scale optical structures (e.g., diffractive grating structures) on a waveguide surface. The optical structures may repeat thousands of times over the waveguide surface. Using techniques described herein, gradual changes in the shape (e.g., shape and/or size defined in the x-y plane of the waveguide surface, such as spacing between grating lines or shapes of individual diffractive elements) and/or the height (e.g., shape and/or size of the overall structure defined in the z-y or z-x plane perpendicular to the waveguide surface) of the structures can be gradually varied over thousands of repetitions between the structures in a first region of the waveguide surface (e.g., a left end of the waveguide, near an optical input) and a second region of the waveguide surface (e.g., a right end of the waveguide, near an optical output). By gradually varying optical structure shape and/or height over the waveguide surface, the uniformity and/or efficiency of propagation of various wavelengths of light within the waveguide may potentially be improved. For example, some waveguides exhibit reduced out-coupling of light at regions farther from the optical input; by gradually varying the height of diffractive optical structures used to outcouple the light, this effect may be mitigated. In a further example, different regions of a waveguide surface may use different shapes of optical structures to achieve different effects, but this may give rise to visible discontinuities in the behavior of light at the boundaries between these regions; by gradually transitioning from a relatively high height to a relatively lower height, especially if the relatively lower height approaches zero at the boundary between regions, these discontinuities may be mitigated or eliminated.

In some examples, two adjacent regions may contain two different types of structures, such as diffractive structures in a first region and non-diffractive structures in an adjacent second region. In some such examples, the height and/or other shape of the diffractive structures can be modulated over the surface area of the first region such that the diffractive properties (e.g., out-coupling efficiency) of the diffractive structures diminish (e.g., outcoupling efficiency approaches zero) with proximity to the boundary with the second region.

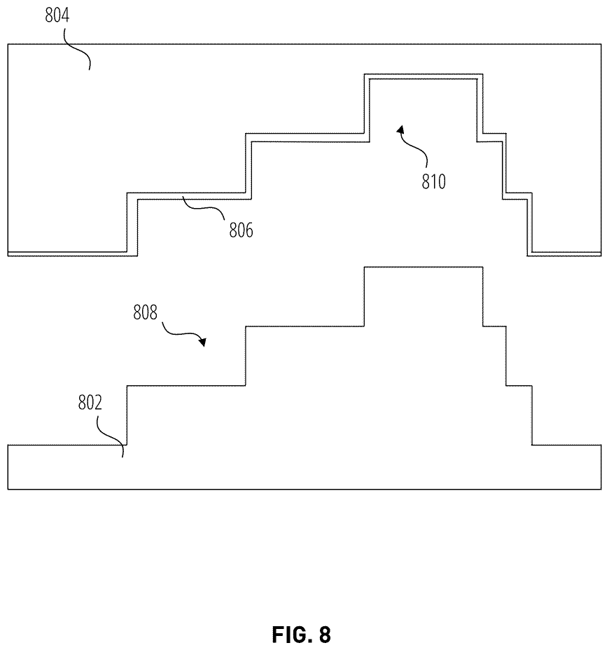

An example of a hard master formed using examples described herein is described with reference to FIG. 8 below.

FIG. 2 shows a substrate 202 having a surface 204. A first mask 206, such as a thin chrome mask, has been formed on the surface 204. The first mask 206 has been patterned such that a plurality of first-etch regions 208 of the surface 204 are exposed.

In some examples, the first mask 206 is formed through a multi-step lithography operation. A uniform thin layer of first mask material (e.g., chrome) is formed on the substrate surface and then covered with a uniform thicker layer of material defining a second mask. The second mask may be a resist mask that is significantly thicker than the thin layer of first mask material but is not as robust to the etch into the substrate 202 (e.g., a dry etch).

A high-resolution first lithography operation (e.g., a high-resolution electron beam write) is then used to etch through the second mask to expose regions of the first mask corresponding to the first-etch regions. The first mask is then etched through to the substrate surface, e.g., by dry or wet etching, thereby patterning the first mask (e.g., as patterned in FIG. 2 as first mask 206) to expose the first-etch regions 208 of the surface 204. Finally, the first etch is performed into the substrate 202, e.g., by dry etching, as shown in FIG. 3 below.

It will be appreciated that, in some cases, the first mask 206 may be formed and patterned using other suitable lithography techniques. Similarly, other masks described herein can be formed and patterned by any suitable lithography technique. Various examples of lithographic etching processes for forming diffraction gratings using multi-layered applications of resist films, screening films, and phase masks are described by the Kurihara reference (U.S. Pat. Pub. No. 2004/0131949 A1), which is hereby incorporated by reference in its entirety.

FIG. 3 shows the substrate 202 of FIG. 2 after performance of the first etch. An etch, such as a dry etch, is performed through the first mask 206 to etch into the exposed first-etch regions 208 of the surface 204 of the substrate 202 in accordance with operation 102. The apertures formed by the first etch 302 extend to a first depth 304 into the substrate 202 at the first-etch regions 208.

In some examples, the first-etch regions 208 may be very small, such as on the order of nanometers or tens of nanometers. The first depth 304 may be on the order of nanometers or tens of nanometers, such as less than 10 nanometers. Examples described herein may be suitable for the formation of nanometer-scale structures, such as depressions in a hard master for imprinting diffractive optical structures onto or into waveguides.

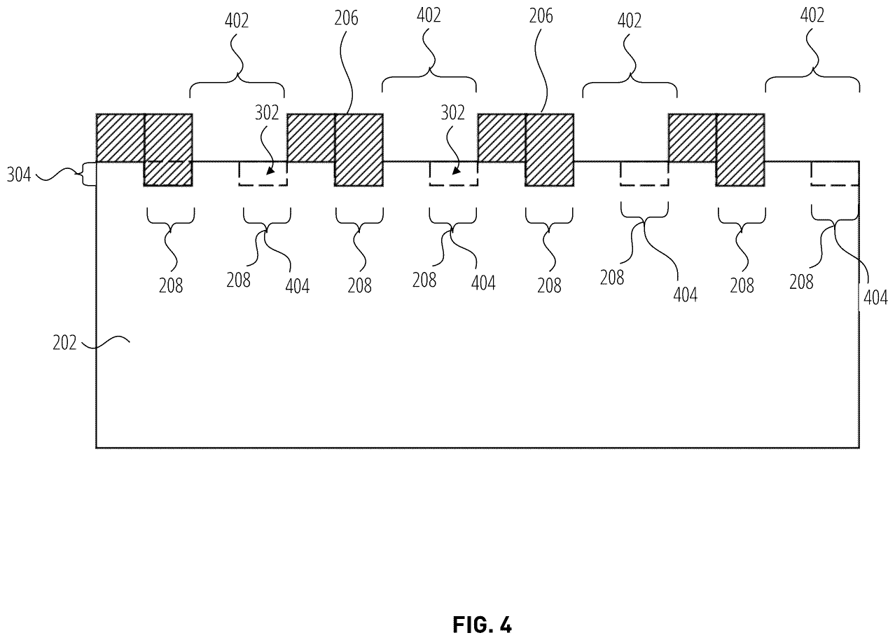

FIG. 4 shows the substrate 202 of FIG. 3 after editing of the first mask 206 or re-formation of the first mask 206 to define a plurality of second-etch regions 402. In some examples, the second-etch regions 402 overlap at least partially with one or more of the first-etch regions 208 to define one or more overlap regions 404. In some examples, editing or re-formation of the first mask 206 may include additional lithography steps, as described above.

FIG. 4 shows portions of the first mask 206 formed within the apertures or depressions formed by the first etch 302. Whereas the illustrated example shows the first mask 206 having a flat upper surface, in some examples, the first mask 206 may have an irregular upper surface due to the irregular depths at which its various portions may be deposited.

Thus, in some examples, the first mask 206 is edited or re-formed to expose the second-etch regions 402. In some examples, the editing may include removal of portions of the first mask 206 (as in the illustrated example). In some examples, the editing may include addition or deposition of portions of the first mask 206 (also as in the illustrated example). In some examples, re-formation of the first mask 206 includes removing the previous first mask 206 and depositing or otherwise forming a new first mask 206 having a different pattern.

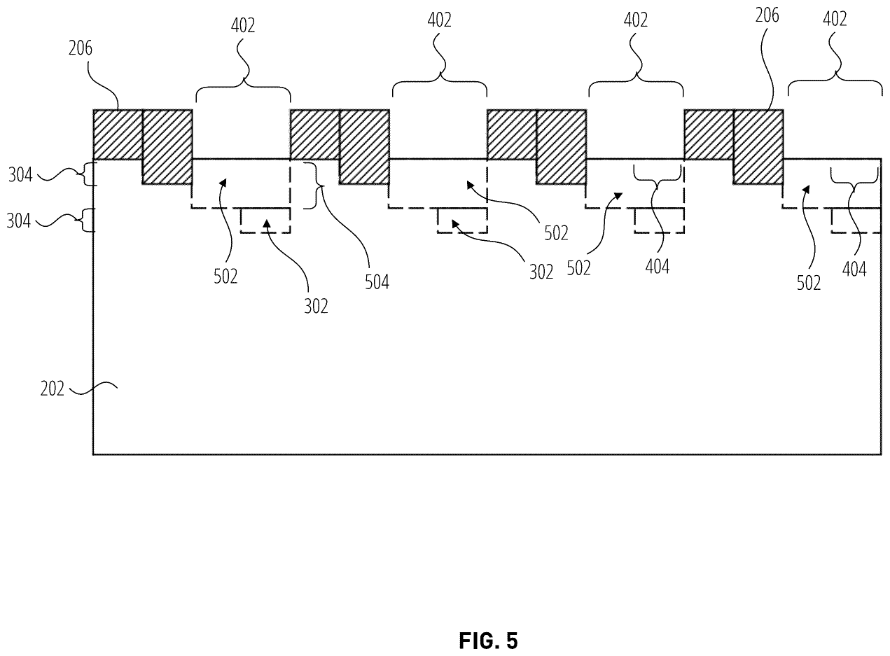

FIG. 5 shows the substrate 202 of FIG. 4 after performance of a second etch. A second etch, such as a dry etch, is performed through the re-formed or edited first mask 206 to etch into the exposed second-etch regions 402 of the surface 204 of the substrate 202 in accordance with operation 104. The apertures formed by the second etch 502 extend a second depth 504 into the substrate 202 at the second-etch regions 402. It can be seen in FIG. 5 that some depressions created by the second etch 502 are newly created at the second depth 504, whereas other depressions—namely, those overlapping with the first-etch regions 208 to define the overlap regions 404—are deepened from the first depth 304 to a depth equal to the first depth 304 plus the second depth 504.

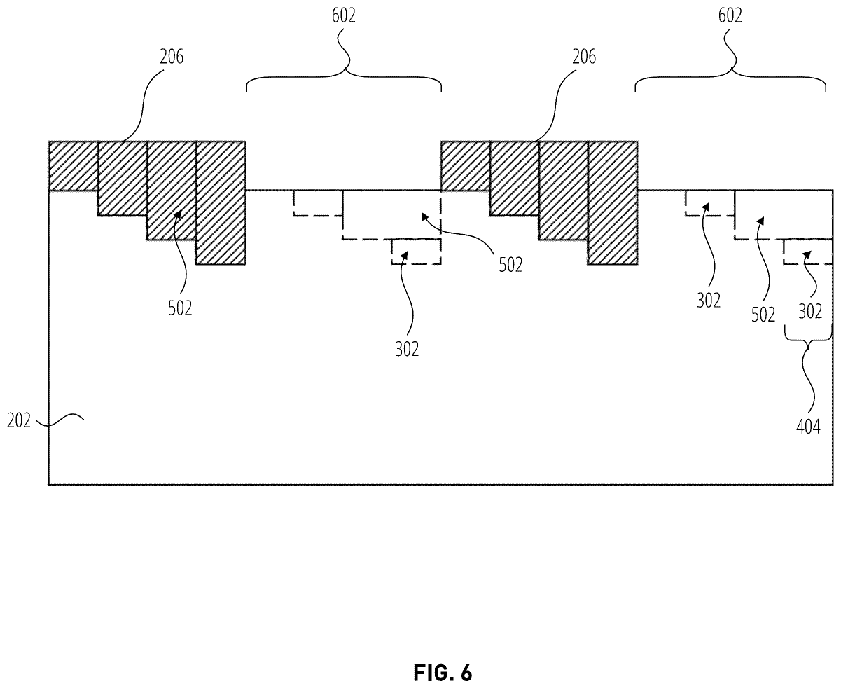

FIG. 6 shows the substrate 202 of FIG. 5 after another editing or re-formation of the first mask 206 according to a different pattern than the pattern of the first mask 206 used for the second etching operation 104 shown in FIG. 5. In the illustrated example, the first mask 206 as edited or re-formed occludes a subset of the second-etch regions 402 and a subset of the first-etch regions 208 and exposes another subset of the second-etch regions 402 and another subset of the first-etch regions 208, to define one or more third-etch regions 602 at least partially overlapping one or more of the overlap regions 404.

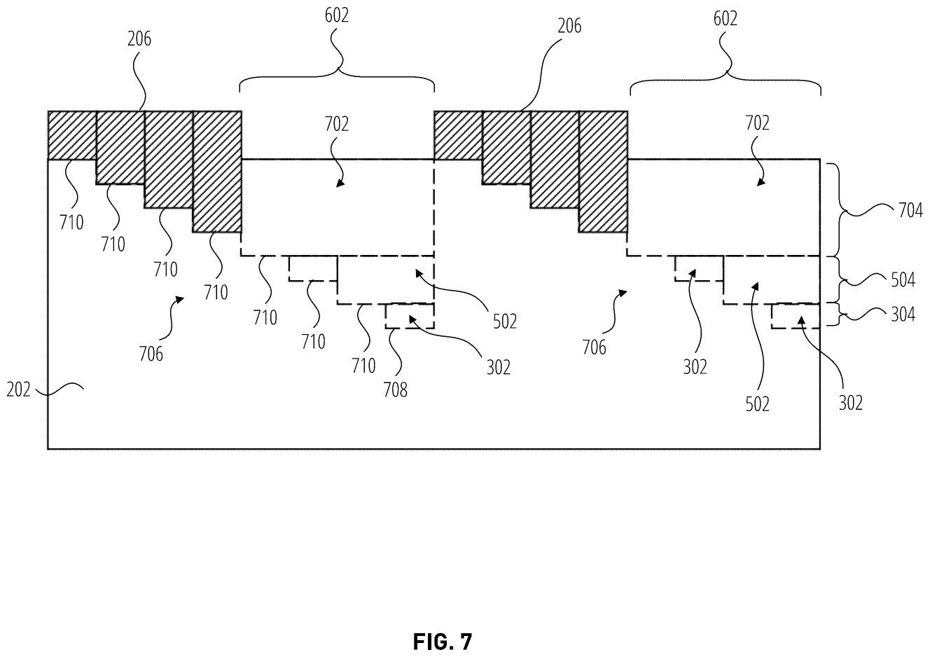

FIG. 7 shows the substrate 202 of FIG. 6 after further editing or re-formation of the first mask 206 and performance of a third etch.

In some examples, the third etch proceeds similarly to the second etch. A third etch, such as a dry etch, is performed through the edited or re-formed first mask 206 to etch into the exposed third-etch regions 602 of the surface 204 of the substrate 202 in accordance with operation 106. The apertures formed by the third etch 702 extend a third depth 704 into the substrate 202 at the third-etch regions 602. It can be seen in FIG. 7 that some depressions created by the third etch 702 are newly created at the third depth 704, whereas other depressions—namely, those overlapping with the first-etch regions 208 and/or the second-etch regions 402—are deepened from the first depth 304, second depth 504, or first depth 304 plus second depth 504, to a depth equal to the existing depression depth plus the third depth 704.

The result of the operations shown in FIG. 2 through FIG. 7 is a structure etched into the substrate 202 and defined by a plurality of depressions, including one or more deep depressions 708 of a maximum depth and a plurality of shallower depressions 710 at less than the maximum depth. The deep depressions 708, formed at the overlap of the third-etch regions 602 with the overlap regions 404, have a depth equal to a sum of the first depth 304, the second depth 504, and the third depth 704. The shallower depressions 710 may have a range of different depths depending on the pattern of overlap of the three etches. Each shallower depression 710 has a respective depth equal to a sum of one or two of the following depths: the first depth 304, the second depth 504, and the third depth 704.

In some examples, such as the illustrated example, the deep depression 708 and plurality of shallower depressions 710 define a stepped structure 706 having seven adjacent steps of successively deeper depths below the surface 204 of the substrate 202.

In some examples, the plurality of shallower depressions 710 includes one or more depressions having a depth equal to the first depth 304, one or more depressions having a depth equal to the second depth 504, and one or more depressions having a depth equal to the third depth 704. In some examples, the plurality of shallower depressions 710 includes one or more depressions having a depth equal to a sum of the first depth 304 and the second depth 504, one or more depressions having a depth equal to a sum of the first depth 304 and the third depth 704, and one or more depressions having a depth equal to a sum of the second depth 504 and the third depth 704.

Various different materials may be used in various examples for the substrate 202, first mask 206, and/or second mask. In some examples, the substrate 202 may be a crystal material, such as quartz or silicon. Various different etching and/or lithography techniques may be used that are suitable for the materials selected. In some examples, where the substrate 202 is quartz, the first mask 206 may be a chrome mask, the second mask may be a resist mask (such as a mask formed from a PMMA based resist material) that is thicker than the chrome mask, and the performing of the first etch 302, the second etch 502, and the third etch 702 includes dry etching, as described above, However, it will be appreciated that any suitable materials and any suitable etching techniques can be used in various different examples.

In some examples, the first depth 304, second depth 504, and third depth 704 are all different depths. For example, the first depth may be shallower than the second depth, and the second depth may be shallower than the third depth. In order to maximize the range of depths that can be achieved by the techniques described herein, some examples may use respective etch depths that are double the depth of the previous etch, thereby allowing a degree of granularity in depth equal to the smallest depth. In such examples, therefore, the second depth 504 is equal to twice the first depth 304, and the third depth 704 is equal to twice the second depth 504.

Nanometer-scale structures may be created by the examples described here using nanometer-scale etch depths. In some examples, the first depth, second depth, and third depth are each less than 100 nanometers. In some examples, the first depth, second depth, and third depth are each less than 200 nanometers. In some examples, the first depth, second depth, and third depth are each less than 250 nanometers. In some examples, the first depth, second depth, and third depth are each less than 300 nanometers. Even greater etch depths can be used in some cases, depending on the materials and the etching and lithography techniques used, and depending on the intended application of the etched substrate. Furthermore, fine gradations between nanoscale structures can be achieved using these techniques. In some examples, at least one of the first depth, second depth, or third depth is less than 10 nanometers. The depths etched using techniques described herein can be any depth suitable for the intended application, limited only by the physical capabilities of the etching techniques.

In some examples, as described above with reference to operation 108 of method 100, additional etches may be performed beyond the third etch 702. Any additional etches after the third etch 702 may also be successively deeper than any previous etches, and/or the etched regions may be successively wider than those of the previous etches.

FIG. 8 shows example structures that may be created, directly or indirectly, by method 100 or other example techniques described herein. The structure etched into the substrate 202 by method 100 may be used as a hard master for subsequent formation of one or more stamps and/or imprints of the hard master. Stamps created from a hard master may subsequently be used to imprint further structures. The final product of such further operations may be a desired structure, such as a stepped diffraction grating formed on a waveguide surface. In some examples, the final product may be formed by multiple repeated impressions of an intermediate negative replica over a larger surface. In some examples, an intermediate negative replica may be formed by multiple repeated impressions of a hard master (or other intermediate stamp, template, or model) over a larger surface.

In some examples, the hard master is a positive model 802 of the final desired product (or a portion thereof), such as one or more lines of a stepped diffraction grating. In the illustrated example, the positive model 802 is a hard master directly etched into the substrate 202 such that its upper side 808 is defined by the depressions defined by the etches of method 100.

One or more intermediate negative replicas may be formed from the hard master, each intermediate negative replica acting as a negative model 804 of the desired structure, such that the intermediate negative replica can be used to imprint the desired structure into a deformable material such as resin. In some examples, an intermediate negative replica may be formed by depositing or directing a liquid, or an otherwise conforming or deformable material, over the upper side 808 of the hard master (e.g., positive model 802) to fill the depressions on the upper side 808, such that the underside 810 of the intermediate negative replica is a negative of the upper side 808 of the hard master. For example, a liquid material can be used to coat the upper side 808 of the hard master before curing or otherwise hardening the liquid material to form an intermediate negative replica, which can then be separated from the hard master for use in subsequent operations. In some examples, the underside 810 of the intermediate negative replica may also be treated with a coating, such as a metal layer 806, to improve the imprinting performance of the intermediate negative replica. In some examples, an intermediate negative replica may need to be flexible in order to flex when being applied to make an imprint, and/or when being peeled away from the imprinted surface. Thus, if a hard master is formed from a rigid material such as silicon or quartz, it may not be suitable for direct imprinting of a final product in some cases. However, in some cases, a rigid hard master may be used for imprinting, and in other cases, an intermediate negative replica can be formed from a rigid material and used for further imprinting operations.

In some examples, the hard master is a negative model 804 of the desired structure. The hard master may be used directly as a stamp (e.g., an intermediate negative replica), or may be used to form one or more positive models 802 of the desired structure, which may in turn be used to form intermediate negative replicas. Thus, in some examples, a device may be provided that includes one or more structures imprinted by a hard master formed using the techniques described herein.

In some examples, if the substrate is etched to create a positive model of the desired final product, an intermediate negative replica may be created for imprinting structures into a deformable material (e.g., an intermediate negative replica that serves as a negative model of the desired final product). The intermediate negative replica can be formed by performing the example methods described herein, followed by impressing a deformable material over the surface of the substrate and into the plurality of depressions to form the intermediate negative replica. Conversely, if the substrate is etched to serve as a negative model of the desired final product, an intermediate positive model may be formed from the etched substrate, and the intermediate negative replica may be created from the intermediate positive model. In some examples, the same stamp may be imprinted repeatedly into different portions of a waveguide surface in order to form repeating patterns of structures. In some examples, multiple stamps may be created having different patterns of structures, and each stamp is imprinted one or more times over one or more respective regions of the waveguide surface.

It will thus be appreciated that techniques described herein may be used to create either depressed structures extending downward into a waveguide surface, or protruding structures extending above a waveguide surface, or both. In some examples, a stamp may be formed that imprints a pattern of structures into a resin or other deformable material wherein the pattern may include depressed and/or protruding structures. This may enable the creation of different types of diffractive structures using a single stamp, e.g., both an input grating and an output grating.

When using a single pattern of etches to define both depressed and protruding structures, some examples may define a “floor” for the pattern indicating a baseline or normalized depth corresponding to a flat surface of the waveguide to be imprinted, relative to which a given structure may be considered to depress into or protrude above. When making repeated imprints of a stamp into different locations on the waveguide surface, it may be necessary to align the floors of the repeated imprints to a common level such that the multiple imprints all share a common floor or flat waveguide surface depth. In stamps defining only protruding structures or only depressed structures, the floor may be considered the highest protruding surface or the lowest depressed surface, respectively, of the stamp.

Examples described herein may be used in some cases to manufacture nanometer-scale optical structures, such as diffractive optical elements on a surface of a waveguide. By etching depressions having a large number of different depths, the height of the structures imprinted thereby can be modulated to a high degree of precision and over a large range. This may enable the fabrication of patterns of structures, such as patterns of repeating structures (e.g., lines of diffraction gratings or arrays of 2 dimensional diffractive features across the surface of the waveguide), that gradually change in height and/or shape from one region of a surface to another. Thus, in some examples, the first etch, second etch, third etch, and one or more additional etches are used to form a large number (e.g., at least 1000) of depressions distributed over a first region of the surface 204 of the substrate 202 to form a first plurality of repeating structures (e.g., negative or positive models for repeating structures on a waveguide surface). The first etch, second etch, third etch, and one or more additional etches are also used to form a large number (e.g., at least 1000) of depressions distributed over a second region of the surface 204 of the substrate 202 to form a second plurality of repeating structures. The second plurality of repeating structures differ from the first plurality of repeating structures, e.g., in height and/or in shape.

In some examples, the second plurality of repeating structures have different shapes defined within a plane parallel to the surface 204 of the substrate 202 than the first plurality of repeating structures.

In some examples, the second plurality of repeating structures have different depths than the first plurality of repeating structures. Gradual modulation of the repeating structures' height over the surface can be used to achieve various beneficial effects that may address one or more technical problems in the field of optical devices, as described above in reference to FIG. 1. In some examples, the reduced out-coupling of light at regions farther from an optical input to a waveguide may be mitigated by forming diffractive optical structures (e.g., output diffraction grating lines) that have higher outcoupling efficiency in regions farther from the input grating than in regions closer to the input grating. This modulation of outcoupling efficiency may be achieved, in some cases, by increasing grating height in the regions where greater outcoupling efficiency is desired. Thus, regions of the waveguide surface close to the input grating may include repeating diffractive structures having a relatively low height, regions of the waveguide surface far from the input grating may include repeating diffractive structures having a relatively higher height, and the height of the repeating diffractive structures in between those regions may have their height gradually modulated between the relatively low height and the relatively higher height using the techniques described herein.

In some examples, optical discontinuities between distinct waveguide surface regions may be mitigated by fading the height of the diffractive structures near a region without diffractive optical structures, or a region with a different pattern of diffractive structures, such that those diffractive structures near the boundary between the regions have a height approaching zero. The height of the repeating diffractive structures may be gradually decreased from a maximum height to a minimum height as proximity to the boundary with the other region increases. In some cases, the minimum height may be zero or a small value relative to the maximum height (e.g., less than half of the maximum height). Thus, in some examples, the second plurality of repeating structures (near the boundary between regions) may have a depth that is less than half as deep as a depth of the first plurality of repeating structures, and the region where the second plurality of repeating structures are formed is adjacent to a region of the surface of the substrate having no repeating structures. Increased height of repeating diffractive optical structures may give rise, in some cases, to decreased strength of zero-order transmission and reflection and increased strength of higher orders of light, e.g., outcoupling diffractive orders.

Similarly, optical discontinuities between regions with diffractive structures and adjacent regions with non-diffractive structures may be mitigated by diminishing the diffractive properties of the diffractive structures as they approach the boundary between the regions, as described above.

FIG. 9 illustrates an example implementation of operation 102 and operation 104. Although the example flow chart depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, at operation 902, a first mask is formed over the surface of the substrate, exposing the first-etch regions. As described above, the first mask may be a relatively thin mask configured to be robust to dry etching of the substrate, such as a thin chrome mask deposited on the surface of the substrate and selectively etched away to expose the first-etch regions using wet etching.

According to some examples, at operation 904, etching is performed to the first depth at the first-etch regions. After the first mask has been removed from the first-etch regions using wet etching, a dry etching operation may be used to etch into the substrate to the first depth.

According to some examples, at operation 906, a second mask is formed over a first portion of the first mask, leaving exposed a second portion of the first mask. In some examples, the second mask is a resist mask that is significantly thicker than the first mask but is not as robust to the etch into the substrate (e.g., a dry etch). The increased thickness of the second mask allows it to resist the etch (e.g., dry etch) into the substrate 202; however, the increased thickness may also result in a larger aspect ratio, leading to less precision in the etch directionality than the thin first mask used for the initial, potentially high-frequency and accordingly highly precise, etch pattern. The first portion of the first mask covered by the second mask may include the first-etch regions that do not overlap with the second-etch regions, whereas the second portion of the first mask left exposed by the second mask may include the first-etch regions that do overlap with the second-etch regions. The overlap of the first-etch regions with the second-etch regions are referred to herein as overlap regions, as described above with reference to FIG. 4.

According to some examples, at operation 908 the first mask can be edited to expose the second-etch regions. In some examples, the first mask may be edited by removal of exposed regions of the first mask, e.g., using wet etching. In some examples, the first mask may be edited by deposition of additional first mask material on exposed regions of the substrate surface.

According to some examples, at operation 910 etching is performed to the second depth at the second-etch regions. As described above with reference to the first etch, the second etch may be performed as a dry etch in some examples, and may include two or more stages to successively deepen the second etch to the second depth.

Thus, operation 902 and operation 904 can be considered to be sub-steps of operation 102 in some examples, and operation 906, operation 908, and operation 910 can be considered to be sub-steps of operation 104 in some examples.

Third and/or subsequent etches may be performed according to a similar sequence of operations in some examples.

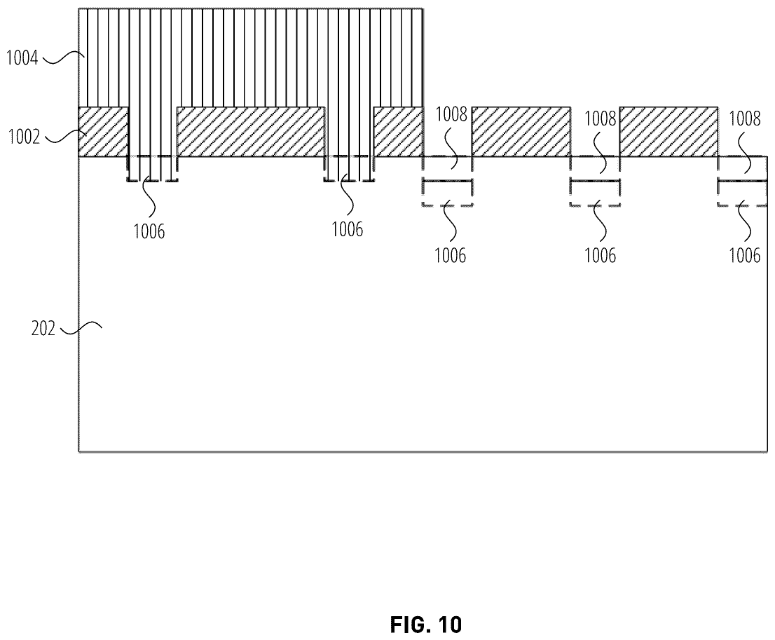

An example of re-using the first mask to perform the second etch is described below with reference to FIG. 10 through FIG. 12.

FIG. 10 shows a substrate 202 over which has been formed a first mask 1002, as in FIG. 2 (and according to operation 902). A first etch 1006 has been formed into the substrate 202 through the first mask 1002 at the first-etch regions 208, as in FIG. 3 (and according to operation 904).

However, after formation of the first etch 1006, the second mask 1004 has been formed over the first mask 1002 (according to operation 906). In the illustrated example, the second mask 1004 occludes a subset of the first-etch regions 208 and exposes another subset of the first-etch regions 208. The exposed subset of first-etch regions 208 can be considered to be the second-etch regions 402, and also the overlap regions 404. A second etch 1008 has been performed to create depressions into these overlap regions 404. In the illustrated example, the second etches 1008 have the same depth as the first etches 1006 (in other words, the first depth is equal to the second depth).

Thus, the example shown in FIG. 10 has two separate etches performed using a single chrome mask (first mask 1002), with the resist mask (second mask 1004) occluding only a subset of the first-etch regions etched by the first etch.

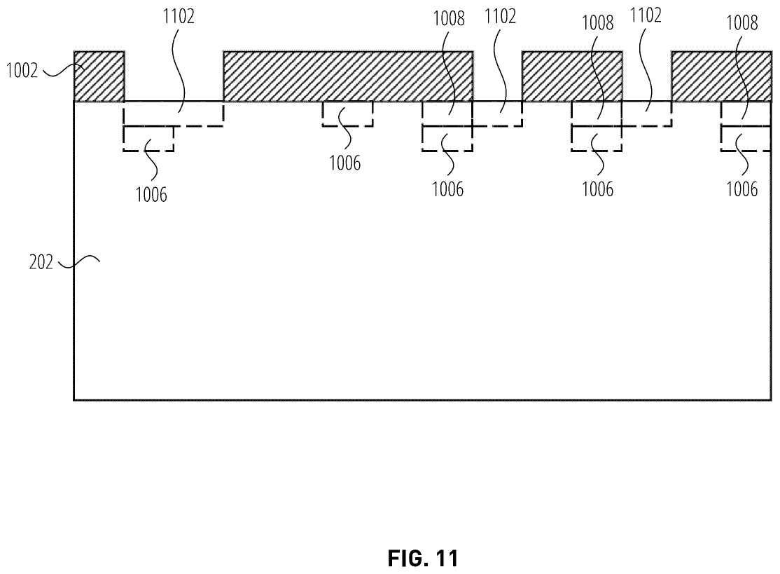

FIG. 11 shows the substrate 202 of FIG. 10, with the second mask 1004 removed and the first mask 1002 edited or re-formed into a new pattern. The new pattern of the first mask 1002 leaves exposed a set of third-etch regions, one of which (on the left) overlaps with an overlap region 404 in this example. A third etch 1102 has been performed to form a further set of depressions at the third-etch regions.

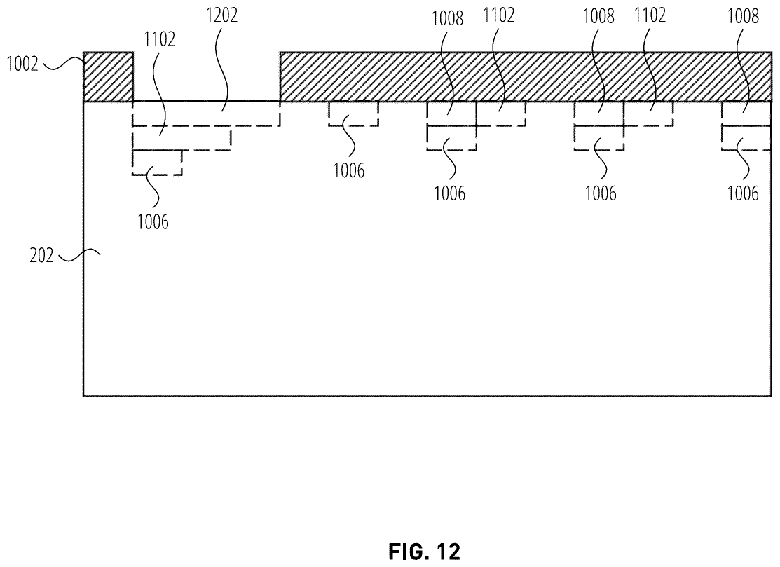

FIG. 12 shows the substrate 202 of FIG. 11, with the first mask 1002 edited or re-formed into a further new pattern. The new pattern of the first mask 1002 leaves exposed a single fourth-etch region that overlaps with the left-most depression. A fourth etch 1202 has been performed to deepen and widen the left-most depression and create a stepped structure.

Thus, the combination of the first mask and second mask can be used, in some cases, to create a variety of different structures having varying shapes and heights. Even if the etches have identical depths (as in the illustrated example), different patterns of depressions can be formed by selectively occluding parts of the first mask using the second mask before performing a subsequent etch.

The examples disclosed with reference to FIG. 1 to FIG. 12 generally define a process of forming linear stepped structures, with the description of these structures referring to a single cross-sectional view of each structure. However, the process of subtractive etching may be applied to the formation of other structures, such as various three-dimensional structures that may be varied in shape along all three dimensions, such that the cross-sectional shape of the structure varies at different locations.

Examples of such three-dimensional structures include, but are not limited to, hemispheres, circular cones, rectangular cones, rectangular pyramids, triangular pyramids, and cruciform pyramids. The process commences with the formation of an initial first etch 302 through first mask 206, which may define a 2 dimensional shape, such as a circle, a rectangle, a triangle or a cruciform. First mask 206 is then enlarged (e.g., partially removed) to expose unetched substrate 202, which is etched to form second etch 502. The process is repeated, at each step enlarging the aperture(s) in the first mask 206 to reveal more unetched substrate 202. With each additional etch step, the first etch 302 is moved deeper into the substrate 202. The process may be repeated until the required etch depth has been achieved.

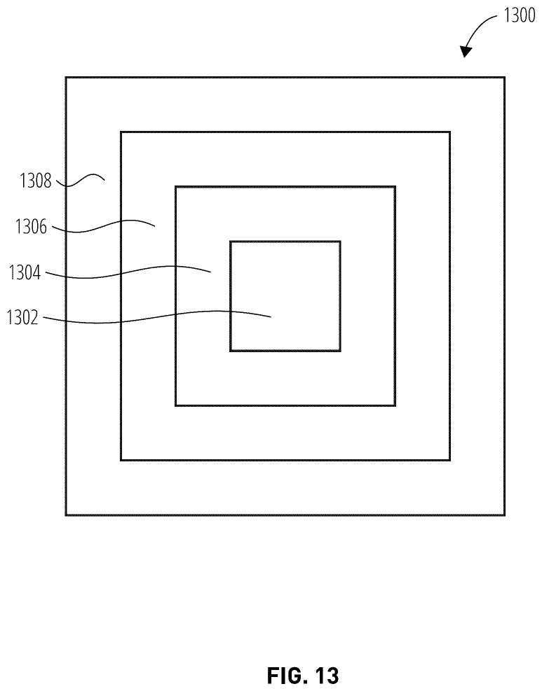

FIG. 13 shows an example of a rectangular pyramid 1300 formed into a substrate by stacked etches as described above. The rectangular pyramid 1300 is shown in an overhead view, looking down toward the surface of the substrate. A first etch 1302 defines the peak of the rectangular pyramid 1300. The first etch 1302 is followed by a second etch 1304, third etch 1306, and fourth etch 1308 defining successively lower tiers of the pyramid and etching deeper into the previously-etched regions to deepen the depressions defined by the previous etches.

If each etch 1302, 1304, 1306, and 1308 is of the same depth, the rectangular pyramid 1300 will have four sides that are substantially linear or constant in slope. However, if the depths of the etches are successively increased, the sides of the rectangular pyramid 1300 will substantially define a curve that is concave upward, such that the structure formed into the substrate resembles a four-sided dome. A circular dome or hemisphere may be formed using similar techniques but employing masks defining etch regions that are more circular instead of rectangular. Similarly, circular masks combined with constant etch depths can be used to form a cone.

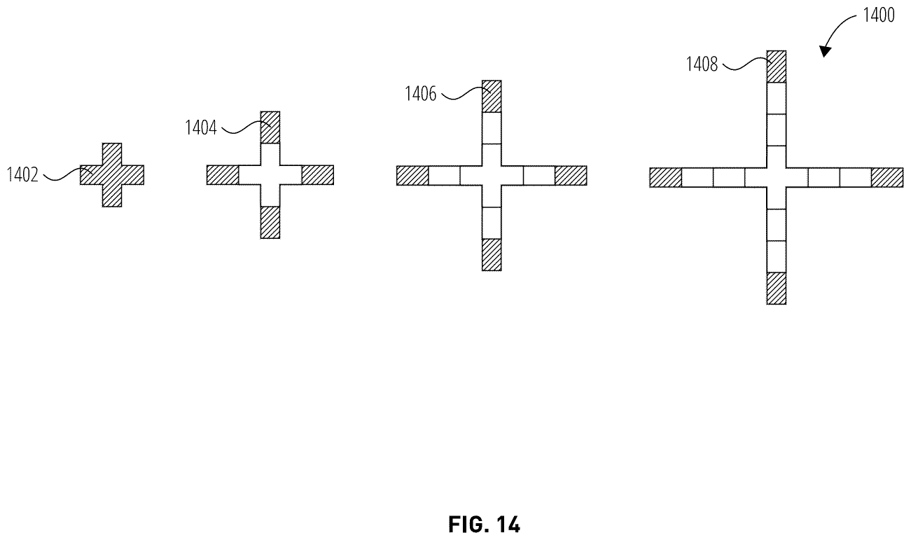

FIG. 14 shows an example of a sequence of stacked etches used to form a cruciform pyramid 1400 into a substrate as described above. A first etch 1402 is performed into a small cruciform region, followed by subsequent stacked cruciform etches (second etch 1404, third etch 1406, and fourth etch 1408) to form a cruciform pyramid 1400 having four staircase-like structures radiating in four directions from the center.

As in the rectangular pyramid 1300, the stepped structures of the cruciform pyramid 1400 may have roughly constant slopes if the depths of the etches are identical, but the slopes may curve (e.g., decrease toward the center) if the depths of the etches are varied (e.g., each successive etch is deeper than the previous etches).

It will be appreciated that the rectangular pyramid 1300, cruciform pyramid 1400, and other three-dimensional shapes described above may be formed by performing a first etch into a first-etch region defining a two-dimensional shape (e.g., a rectangle, a circle, a cross) on the surface of the substrate, followed by performing a second etch into a second-etch region encompassing the two-dimensional shape, followed by performing a third etch into a third-etch region encompassing the second-etch region.

### CONCLUSION

As described above, examples described herein may address one or more technical problems associated with subtractive manufacturing and/or fabrication of optical structures. In some examples, the total number of different depths of depressions that may be formed by N etches is equal to 2^{N}−1. In some examples, the uniformity and/or efficiency of propagation of various wavelengths of light within the waveguide and/or outcoupling of light out of the waveguide may be improved by gradually varying the height of diffractive optical structures used to outcouple the light across a waveguide surface based on proximity to an input grating. In some examples, optical discontinuities between waveguide surface regions having different patterns of repeating optical structures may be mitigated or eliminated by gradually transitioning from optical structures having a relatively high height to optical structures having a relatively lower height approaching the boundary between regions. Other technical features may be readily apparent to one skilled in the art from the figures, descriptions, and claims herein.

Thus, in accordance with various examples described herein, precisely and widely depth-modulated structures, and methods for the subtractive manufacture thereof, are provided.

Example 1 is a device comprising: a waveguide comprising a surface; and a plurality of repeating structures formed on or in the waveguide surface by imprinting a negative model over at least a portion of the waveguide surface, the negative model being formed by operations comprising: performing a first etch of a first depth into a plurality of first-etch regions of a surface of a substrate; performing a second etch of a second depth into a plurality of second-etch regions of the surface of the substrate, the plurality of second-etch regions being different from the plurality of first-etch regions but at least partially overlapping the plurality of first-etch regions at one or more overlap regions; and performing a third etch of a third depth into one or more third-etch regions of the surface of the substrate, the one or more third-etch regions being different from the plurality of first-etch regions and different from the plurality of second-etch regions but at least partially overlapping at least one of the one or more overlap regions, thereby forming a plurality of depressions comprising: one or more deep depressions having a depth equal to a sum of the first depth, the second depth, and the third depth; and a plurality of shallower depressions, each shallower depression having a respective depth equal to a sum of one or two of the following depths: the first depth, the second depth, and the third depth.

In Example 2, the subject matter of Example 1 includes, wherein: the first depth, second depth, and third depth are all different depths.

In Example 3, the subject matter of Example 2 includes, wherein: the plurality of shallower depressions comprises: one or more depressions having a depth equal to the first depth; one or more depressions having a depth equal to the second depth; and one or more depressions having a depth equal to the third depth.

In Example 4, the subject matter of Example 3 includes, wherein: the plurality of shallower depressions comprises: one or more depressions having a depth equal to a sum of the first depth and the second depth; one or more depressions having a depth equal to a sum of the first depth and the third depth; and one or more depressions having a depth equal to a sum of the second depth and the third depth.

In Example 5, the subject matter of Example 4 includes, wherein the operations further comprise: performing one or more additional etches, each additional etch being of a respective additional depth, into a respective one or more additional-etch regions of the surface of the substrate, such that: a total number of etches performed is equal to N, N being greater than 3; and a total number of different depths of depressions formed by the first etch, second etch, third etch, and one or more additional etches is equal to 2N−1.

In Example 6, the subject matter of Examples 4-5 includes, wherein: the deep depression and plurality of shallower depressions define a stepped structure having seven adjacent steps of successively deeper depths below the surface of the substrate.

In Example 7, the subject matter of Examples 1-6 includes, wherein: the first depth is shallower than the second depth; and the second depth is shallower than the third depth.

In Example 8, the subject matter of Examples 1-7 includes, wherein: the first depth, second depth, and third depth are each less than 250 nanometers.

In Example 9, the subject matter of Examples 1-8 includes, wherein: at least one of the first depth, second depth, or third depth is less than 10 nanometers.

In Example 10, the subject matter of Examples 1-9 includes, wherein: a first first-etch region of the plurality of first-etch regions defines a two-dimensional shape on the surface of the substrate; a first second-etch region of the plurality of second-etch regions encompasses the two-dimensional shape; and a first third-etch region of the one or more third-etch regions encompasses the first second-etch region, such that the plurality of depressions define a three-dimensional shape formed into the substrate.

In Example 11, the subject matter of Examples 1-10 includes, wherein: the performing of the first etch comprises: forming a first mask over the surface of the substrate, the first mask exposing the first-etch regions; and etching to the first depth at the first-etch regions; and the performing of the second etch comprises: forming a second mask over a first portion of the first mask occluding a first one or more of the first-etch regions, the second mask leaving exposed a second portion of the first mask comprising a second one or more of the first-etch regions; and etching to the second depth at the second-etch regions, the second-etch regions comprising the second one or more of the first-etch regions.

In Example 12, the subject matter of Example 11 includes, after forming the second mask and before etching to the second depth: editing the second portion of the first mask, such that the second-etch regions are defined by the edited second portion of the first mask.

In Example 13, the subject matter of Examples 11-12 includes, wherein: the substrate is quartz; the first mask is formed from a different material from the second mask; and the performing of the first etch, the second etch, and the third etch comprises dry etching.

In Example 14, the subject matter of Examples 1-13 includes, wherein: the plurality of repeating structures comprises: a first plurality of repeating structures formed on or in the waveguide surface in a first region; and a second plurality of repeating structures formed on or in the waveguide surface in a second region; and the negative model is imprinted over the first region and second region of the waveguide surface.

In Example 15, the subject matter of Example 14 includes, wherein: the first plurality of repeating structures comprises a plurality of gaps between each adjacent pair of repeating structures; the second plurality of repeating structures comprises a plurality of gaps between each adjacent pair of repeating structures; and the second plurality of repeating structures have a different height, measured from a top of the repeating structure to a gap adjacent to the repeating structure, than a height of the first plurality of repeating structures measured from a top of the repeating structure to a gap adjacent to the repeating structure.

In Example 16, the subject matter of Example 15 includes, wherein: the height of the second plurality of repeating structures is less than half the height of the first plurality of repeating structures; and the second region is adjacent to a region of the surface of the waveguide having no repeating structures.

In Example 17, the subject matter of Examples 14-16 includes, wherein the operations performed to form the negative model further comprise: forming at least one intermediate model from the substrate having the plurality of depressions; and forming the negative model from the at least one intermediate model.

Example 18 is a device for imprinting structures into a deformable material, the device comprising an intermediate negative replica formed by operations comprising: performing a first etch of a first depth into a plurality of first-etch regions of a surface of a substrate; performing a second etch of a second depth into a plurality of second-etch regions of the surface of the substrate, the plurality of second-etch regions being different from the plurality of first-etch regions but at least partially overlapping the plurality of first-etch regions at one or more overlap regions; performing a third etch of a third depth into one or more third-etch regions of the surface of the substrate, the one or more third-etch regions being different from the plurality of first-etch regions and different from the plurality of second-etch regions but at least partially overlapping at least one of the one or more overlap regions, thereby forming a plurality of depressions comprising: one or more deep depressions having a depth equal to a sum of the first depth, the second depth, and the third depth; and a plurality of shallower depressions, each shallower depression having a respective depth equal to a sum of one or two of the following depths: the first depth, the second depth, and the third depth; and forming the intermediate negative replica by depositing material over the surface of the substrate and into the plurality of depressions.

Example 19 is a device comprising one or more structures imprinted by an intermediate negative replica according to Example 18.

Example 20 is a device comprising a negative model for imprinting a plurality of repeating structures on or in a waveguide surface, the negative model comprising a substrate having formed within a surface thereof a plurality of depressions, the plurality of depressions being formed by operations comprising: performing a first etch of a first depth into a plurality of first-etch regions of the surface of the substrate; performing a second etch of a second depth into a plurality of second-etch regions of the surface of the substrate, the plurality of second-etch regions being different from the plurality of first-etch regions but at least partially overlapping the plurality of first-etch regions at one or more overlap regions; performing a third etch of a third depth into one or more third-etch regions of the surface of the substrate, the one or more third-etch regions being different from the plurality of first-etch regions and different from the plurality of second-etch regions but at least partially overlapping at least one of the one or more overlap regions, thereby forming a plurality of depressions comprising: one or more deep depressions having a depth equal to a sum of the first depth, the second depth, and the third depth; and a plurality of shallower depressions, each shallower depression having a respective depth equal to a sum of one or two of the following depths: the first depth, the second depth, and the third depth.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

It will be appreciated that the various aspects of the methods described above may be combined in various combination or sub-combinations.

What is claimed is:

1. A device comprising:
a waveguide comprising a surface; and
a plurality of repeating structures formed on or in the waveguide surface by imprinting a negative model over at least a portion of the waveguide surface,
the negative model being formed by operations comprising:
performing a first etch of a first depth into a plurality of first-etch regions of a surface of a substrate;
performing a second etch of a second depth into a plurality of second-etch regions of the surface of the substrate, the plurality of second-etch regions being different from the plurality of first-etch regions but at least partially overlapping the plurality of first-etch regions at one or more overlap regions; and
performing a third etch of a third depth into one or more third-etch regions of the surface of the substrate, the one or more third-etch regions being different from the plurality of first-etch regions and different from the plurality of second-etch regions but at least partially overlapping at least one of the one or more overlap regions,
thereby forming a plurality of depressions comprising:
one or more deep depressions having a depth equal to a sum of the first depth, the second depth, and the third depth; and
a plurality of shallower depressions, each shallower depression having a respective depth equal to a sum of one or two of the following depths: the first depth, the second depth, and the third depth.

2. The device of claim 1, wherein:
the first depth, second depth, and third depth are all different depths.

3. The device of claim 2, wherein:
the plurality of shallower depressions comprises:
one or more depressions having a depth equal to the first depth;
one or more depressions having a depth equal to the second depth; and
one or more depressions having a depth equal to the third depth.

4. The device of claim 3, wherein:
the plurality of shallower depressions comprises:
one or more depressions having a depth equal to a sum of the first depth and the second depth;
one or more depressions having a depth equal to a sum of the first depth and the third depth; and
one or more depressions having a depth equal to a sum of the second depth and the third depth.

5. The device of claim 4, wherein the operations further comprise:
performing one or more additional etches, each additional etch being of a respective additional depth, into a respective one or more additional-etch regions of the surface of the substrate, such that:
a total number of etches performed is equal to N, N being greater than 3; and
a total number of different depths of depressions formed by the first etch, second etch, third etch, and one or more additional etches is equal to 2^{N}−1.

6. The device of claim 4, wherein:
the deep depression and plurality of shallower depressions define a stepped structure having seven adjacent steps of successively deeper depths below the surface of the substrate.

7. The device of claim 1, wherein:
the first depth is shallower than the second depth; and
the second depth is shallower than the third depth.

8. The device of claim 1, wherein:
the first depth, second depth, and third depth are each less than 250 nanometers.

9. The device of claim 1, wherein:
at least one of the first depth, second depth, or third depth is less than 10 nanometers.

10. The device of claim 1, wherein:
a first first-etch region of the plurality of first-etch regions defines a two-dimensional shape on the surface of the substrate;
a first second-etch region of the plurality of second-etch regions encompasses the two-dimensional shape; and
a first third-etch region of the one or more third-etch regions encompasses the first second-etch region,
such that the plurality of depressions define a three-dimensional shape formed into the substrate.

11. The device of claim 1, wherein:
the performing of the first etch comprises:
forming a first mask over the surface of the substrate, the first mask exposing the first-etch regions; and
etching to the first depth at the first-etch regions; and
the performing of the second etch comprises:
forming a second mask over a first portion of the first mask occluding a first one or more of the first-etch regions, the second mask leaving exposed a second portion of the first mask comprising a second one or more of the first-etch regions; and
etching to the second depth at the second-etch regions, the second-etch regions comprising the second one or more of the first-etch regions.

12. The device of claim 11, further comprising:
after forming the second mask and before etching to the second depth:
editing the second portion of the first mask, such that the second-etch regions are defined by the edited second portion of the first mask.

13. The device of claim 11, wherein:
the substrate is quartz;
the first mask is formed from a different material from
the second mask; and
the performing of the first etch, the second etch, and the third etch comprises dry etching.

14. The device of claim 1, wherein:
the plurality of repeating structures comprises:
a first plurality of repeating structures formed on or in the waveguide surface in a first region; and
a second plurality of repeating structures formed on or in the waveguide surface in a second region; and
the negative model is imprinted over the first region and second region of the waveguide surface.

15. The device of claim 14, wherein:
the first plurality of repeating structures comprises a plurality of gaps between each adjacent pair of repeating structures;
the second plurality of repeating structures comprises a plurality of gaps between each adjacent pair of repeating structures; and
the second plurality of repeating structures have a different height, measured from a top of the repeating structure to a gap adjacent to the repeating structure, than a height of the first plurality of repeating structures measured from a top of the repeating structure to a gap adjacent to the repeating structure.

16. The device of claim 15, wherein:
the height of the second plurality of repeating structures is less than half the height of the first plurality of repeating structures; and
the second region is adjacent to a region of the surface of the waveguide having no repeating structures.

17. The device of claim 14, wherein the operations performed to form the negative model further comprise:
forming at least one intermediate model from the substrate having the plurality of depressions; and
forming the negative model from the at least one intermediate model.

18. A device for imprinting structures into a deformable material, the device comprising an intermediate negative replica formed by operations comprising:
performing a first etch of a first depth into a plurality of first-etch regions of a surface of a substrate;
performing a second etch of a second depth into a plurality of second-etch regions of the surface of the substrate, the plurality of second-etch regions being different from the plurality of first-etch regions but at least partially overlapping the plurality of first-etch regions at one or more overlap regions;
performing a third etch of a third depth into one or more third-etch regions of the surface of the substrate, the one or more third-etch regions being different from the plurality of first-etch regions and different from the plurality of second-etch regions but at least partially overlapping at least one of the one or more overlap regions,
thereby forming a plurality of depressions comprising:
one or more deep depressions having a depth equal to a sum of the first depth, the second depth, and the third depth; and
a plurality of shallower depressions, each shallower depression having a respective depth equal to a sum of one or two of the following depths: the first depth, the second depth, and the third depth; and
forming the intermediate negative replica by depositing material over the surface of the substrate and into the plurality of depressions.

19. A device comprising one or more structures imprinted by an intermediate negative replica according to claim 18.

20. A device comprising a negative model for imprinting a plurality of repeating structures on or in a waveguide surface, the negative model comprising a substrate having formed within a surface thereof a plurality of depressions, the plurality of depressions being formed by operations comprising:
performing a first etch of a first depth into a plurality of first-etch regions of the surface of the substrate;
performing a second etch of a second depth into a plurality of second-etch regions of the surface of the substrate, the plurality of second-etch regions being different from the plurality of first-etch regions but at least partially overlapping the plurality of first-etch regions at one or more overlap regions; and
performing a third etch of a third depth into one or more third-etch regions of the surface of the substrate, the one or more third-etch regions being different from the plurality of first-etch regions and different from the plurality of second-etch regions but at least partially overlapping at least one of the one or more overlap regions,
thereby forming a plurality of depressions comprising:
one or more deep depressions having a depth equal to a sum of the first depth, the second depth, and the third depth; and
a plurality of shallower depressions, each shallower depression having a respective depth equal to a sum of one or two of the following depths: the first depth, the second depth, and the third depth.
